(19) United States
(12) Patent Application Publication
(10) Pub. No.: US 2017/0136574 A1
(43) Pub. Date: May 18, 2017

(54) METHOD AND DEVICE FOR THE QUALITY ASSURANCE OF AT LEAST ONE COMPONENT DURING THE PRODUCTION THEREOF BY A GENERATIVE PRODUCTION PROCESS

(71) Applicant: MTU Aero Engines AG, Munich (DE)

(72) Inventors: Gunter Zenzinger, Waakirchen (DE); Thomas Hess, Munich (DE); Joachim Bamberg, Dachau (DE); Alexander Ladewig, Bad Wiessee (DE)

(73) Assignee: MTU Aero Engines AG, Munich (DE)

(21) Appl. No.: 15/320,170

(22) PCT Filed: Apr. 29, 2015
(86) PCT No.: PCT/DE2015/000205

§ 371 Date: Dec. 19, 2016

(30) Foreign Application Priority Data
Jun. 26, 2014 (DE) 10 2014 212 246.5

(51) Int. Cl. B23K 26/03; B33Y 10/00; B33Y 40/00; B33Y 50/02; B23K 26/08; B23K 26/342; B23K 31/12; G01N 25/72; B33Y 30/00

(52) U.S. Cl. CPC B23K 26/034; G01N 25/72; B33Y 10/00; B33Y 40/00; B33Y 30/00; B23K 26/08; B23K 26/342; B23K 31/125; B33Y 50/02; B22F 3/1055

(57) ABSTRACT

The invention relates to a method for the quality assurance of at least one component (14) during the production thereof, wherein the production takes place by means of at least one additive manufacturing process, which comprises the following steps: building up the component (14) layer by layer, and themographically recording at least one image of each individual layer applied. In order to facilitate nondestructive crack detection in a metal component (14) during the production process (inspection by means of an online process), at least some of the layers applied are subjected to a controlled heat treatment below the melting point of the material of the component before the thermographic recording of the associated image, wherein the heat treatment causes the last layer applied to radiate heat which, if at least one crack develops in the layer, exhibits a characteristic heat profile at the crack.

The invention relates to a method for the quality assurance of at least one component during the production thereof according to the preamble of patent claim 1, and a device for carrying out the method.

Laser thermography methods that are used as nondestructive test methods (NDT methods) for the detection of cracks in components are known from the prior art. In this connection, the cooling of the surface of the component being tested is detected with a laser thermography camera. These methods are associated with limitations, however, since the component being tested must be encased or enclosed due to safety reasons with laser technology. Due to the high energy of the laser, there occurs a considerable heating of the surface of the component being tested. In the case of a generative or additive manufacturing method, the production process must be interrupted in order to test or inspect the component. A second energy source is necessary for heating the component.

Therefore, the object of the invention is to provide a method that makes possible a nondestructive crack test of a metal component during the production process (inspection by means of an online method) in the case of an additive manufacturing method.

The object is achieved according to the invention by a method according to claim 1. In addition, the object is achieved with a device according to claim 8. Advantageous embodiments of the invention are contained in the dependent claims.

According to the invention, the object is achieved by a method for the quality assurance of at least one component during the production thereof, wherein the production is carried out by means of at least one additive manufacturing method that comprises the following steps:
building up the component layer by layer;
thermographically recording at least one image of each individual layer applied.

At least some of the applied layers are subjected to a controlled heat treatment below the melting point of the material of the component prior to the thermographic recording of the associated image, wherein the heat treatment induces the last layer applied to radiate heat, and when at least one crack occurs in the layer, this radiated heat has a characteristic heat profile at the crack, wherein the heat profile, and consequently the crack, are made visible by means of the thermographic recording belonging to it. A characteristic heat profile at the crack is understood to be a heat distribution that arises at the crack specifically due to a discontinuity in the material. The thermographic unit is, in particular, a non-laser or laser-independent thermographic unit with which there is no heating of the component due to this thermographic unit.

By this means it is possible, during the additive manufacture, to inspect the last layer of a component produced each time during the manufacture. In this way, an inspection is conducted in the form of an online method, by means of which the entire component can be investigated and documented for cracks continuously during the build-up or production thereof. Preferably, each individual layer is subjected to such a treatment.

With the method according to the invention, it is thus possible to conduct an inspection of cracks by means of an online method without significant additional expense. Inner cracks can be detected nondestructively, so that the component can be approved for aviation without subsequent downstream inspections.

In an advantageous embodiment of the invention, the controlled heat treatment produces in the layer a heat radiation that lies in the infrared region at the edge of the visible spectrum and within the detection spectrum of a thermographic unit. Thus, a reduced heat input will be effected, which raises the temperature in the layer locally to a level at which radiated heat will be emitted in the near infrared without producing re-melting thereby. The radiated heat in this case, however, occurs so near the edge of the visible spectrum that a high-resolution thermographic unit can detect the heat distribution.

In a specific embodiment, the heat treatment is carried out by at least one energy source required for the additive manufacturing method, in particular a laser. In this case, no additional energy source is necessary beyond the energy source for the additive manufacturing method.

In an alternative embodiment, at least one energy source that is independent of the additive manufacturing method carries out the heat treatment. In this alternative, the operations of the additive manufacturing method and the heat treatment are separate. In this way, an existing device without online inspection of cracks can be easily retrofitted.

In addition, the additive manufacturing method can be a selective laser melting and/or a selective laser sintering. These methods are particularly well suitable for the additive manufacture of metal components.

According to an advantageous enhancement of the invention, the crack will be corrected by a re-melting of the layer affected by the crack. Not only will the quality of a layer be inspected in this way, but it will also be assured.

In a further improved embodiment of the invention, the images recorded by the thermographic unit will be analyzed and if a crack is detected, a signaling unit will be activated and/or a re-melting of the layer affected by the crack will be triggered. These method steps can be conducted purely manually, fully automatically, or partially automatically or partially manually. Activation of the signaling unit can alert an operator when a crack is detected. The operator can then interrupt the additive manufacture of the component, and can adjust the energy source for the additive manufacturing method, so that the layer affected by the crack will be re-melted. Alternatively, the re-melting of the layer affected by the crack can be triggered automatically. In this case, an alarm signal can be additionally produced.

In addition, the object can be achieved by a device for carrying out the method, this device having at least one additive manufacturing unit and at least one thermographic unit, the device being characterized in that it comprises at least one energy source, by means of which the controlled heat treatment of any individual layer can be conducted. The energy source must be specifically designed so that it can execute the controlled heat treatment. This function makes possible the quality assurance.

In one advantageous embodiment of the invention, the energy source of the additive manufacturing unit is simultaneously the energy source for the controlled heat treatment. For example, the laser already present in the additive manufacturing unit can be used for the heat treatment, so that another energy source is not necessary. A thermographic inspection is achieved in this way without the supplemental integration of additional energy sources and recording systems in the additive manufacturing unit.

In an alternative embodiment of the invention, the energy source of the additive manufacturing unit is independent of the energy source for the controlled heat treatment. Existing equipment can be easily retrofitted in this way.

In another preferred enhancement of the invention, the thermographic unit comprises a high-resolution image-recording device and/or an image-recording device that is sensitive to infrared radiation, and which is based on CCD, CMOS, or sCMOS sensors, in particular. These types of image-recording devices are well suitable for thermographic recording. A rapid, extremely high-resolution thermographic inspection with all the advantages of this testing technique is obtained in this way.

Additionally, the component can be arranged in the additive manufacturing device without an encasing or enclosure during the inspection. This makes possible for the first time the conducting of component inspection in an online method. In laser thermography, which is known from the prior art, the component being tested must be enclosed or encased for safety reasons with laser technology. Also, due to the high laser energy, there may occur an uncontrolled and undesired intense heating of the inspection surface.

In particular, the device comprises at least one display unit, at least one evaluating unit, at least one signaling unit for reporting a crack, and at least one control of the energy source for the additive manufacturing device. The recordings detected by the thermographic unit can be optically presented on the display unit. The evaluating unit serves for data processing. The signaling unit can alert an operator when a crack is detected. The operator can then interrupt the additive manufacture of the component and control the energy source for the additive manufacturing method so that the layer affected by the crack is re-melted. Alternatively, the re-melting of the layer can be automatically triggered from the evaluating unit by means of the control of the energy source for the additive manufacturing method. In this case, the signaling unit can be additionally activated.

An exemplary embodiment of the invention will be explained below in more detail on the basis of five greatly simplified figures. Herein:

FIG. 1 shows a perspective view of an excerpt from a device according to the invention;

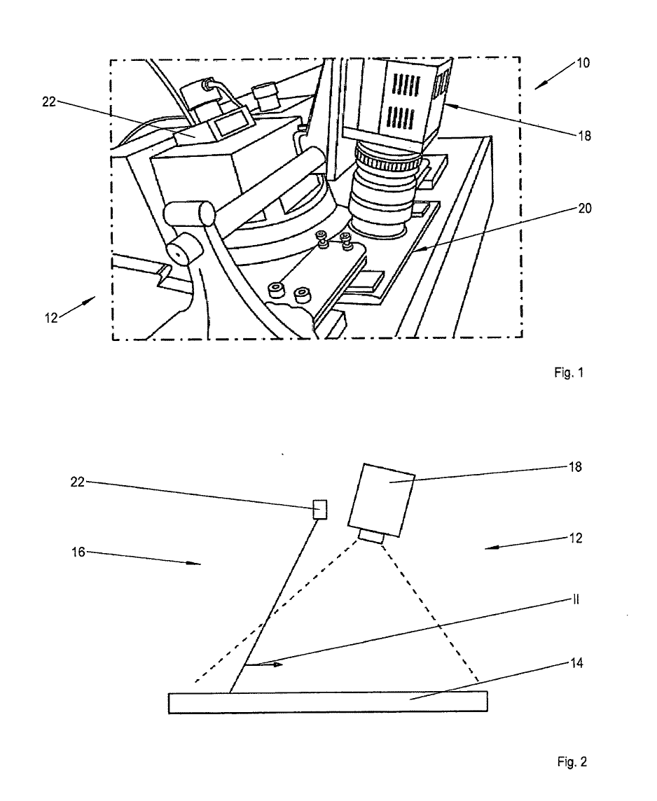

FIG. 2 shows a schematic lateral view of the device according to the invention according to FIG. 1;

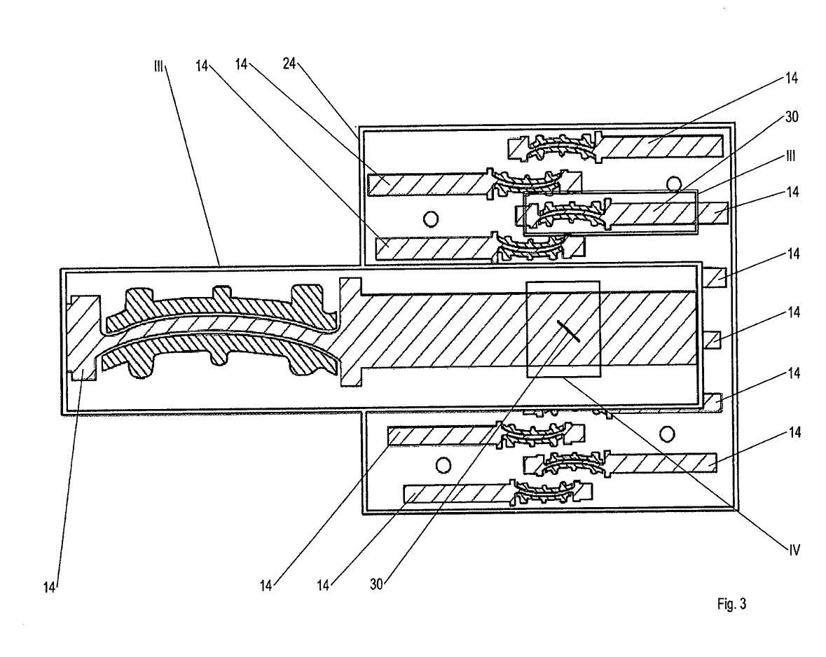

FIG. 3 shows a thermographic recording of the uppermost layer of several components during the execution of the method according to the invention;

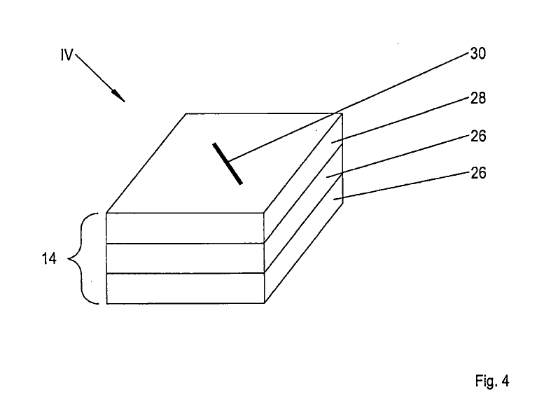

FIG. 4 shows a perspective enlargement of the excerpt IV shown in FIGS. 3; and

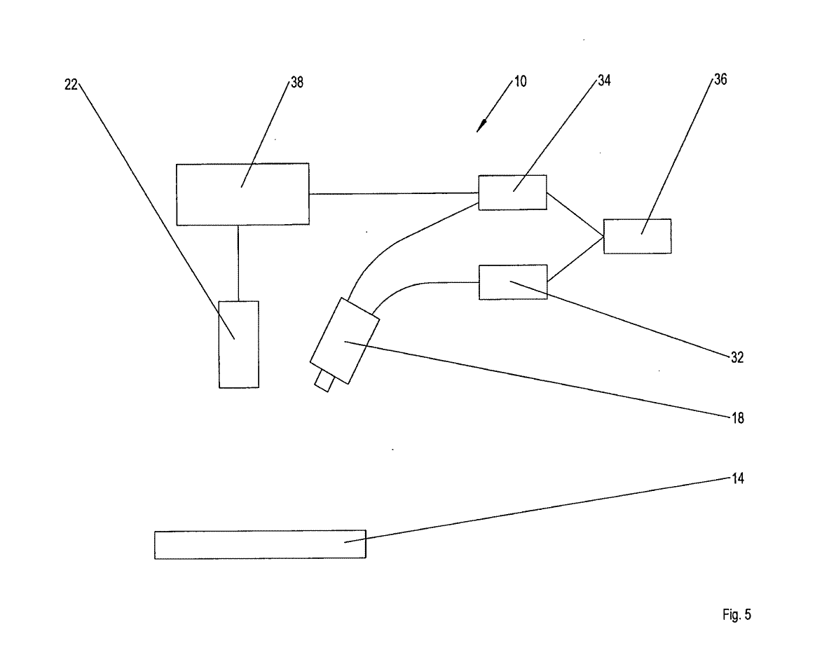

FIG. 5 shows a sketch of the principle of the device according to the invention.

FIG. 1 shows a perspective view of an excerpt of a device 10 according to the invention, which comprises an additive manufacturing unit 12 for producing a component 14. FIG. 1 will be explained in the following in conjunction with FIG. 2, in which a schematic lateral view of the device 10 according to the invention according to FIG. 1 is illustrated. The device 10 serves for carrying out a method for the quality assurance of a component 14 during the production thereof.

The additive manufacturing unit 12 itself is presently designed as a selective laser melting (SLM) system that is known in and of itself, i.e., a laser 22 is the energy source for the melting process. The laser is directed downward, so that the component 14 can be produced from bottom to top in layers introduced on top of one another.

A thermographic unit 18 is arranged above a build-up space 16 (FIG. 2) of the additive manufacturing unit 12 and serves for the purpose of detecting a heat profile in the uppermost layer of component 14 during the production thereof. The thermographic unit 18 is directed onto the uppermost layer of component 14, wherein the detection angle of the thermographic unit 18 covers the build-up space 16, so that the entire uppermost layer of component 14 can be detected. For this purpose, the thermographic unit is disposed in a vertical plane that corresponds here to the image plane in FIG. 2, between the laser 22 and the outer limits of the build-up space 16. In this way, an optical distortion will be avoided that otherwise might occur with a thermographic unit that is inclined too steeply.

A laser protection glass 20 (FIG. 1) is disposed between the build-up space 16 (FIG. 2) and the thermographic unit 18 in order to prevent damaging an sCMOS sensor of the camera by a laser 22 of the additive manufacturing unit 12. The thermographic unit 18 is thus found above the build-up space 16 and outside the beam path II of laser 22 of the additive manufacturing unit 12. In this way, it is assured that the thermographic unit 18 is not found in the beam path II and that laser 22 correspondingly does not suffer any energy losses due to optical elements such as semitransparent mirrors, grids or the like. In addition, the thermographic unit 18 does not influence the production process of component 14 and can also be easily exchanged or retrofitted.

The thermographic unit 18 presently comprises an IR-sensitive sCMOS camera with 5.5 megapixels and an image refresh rate of 100 Hz. Although basically other types of sensors, black-and-white cameras or the like can also be used, a color sensor or a sensor having a broad spectral range supplies comparatively more information, which permits a correspondingly more accurate evaluation of the uppermost layer of component 14.

In order to produce component 14, in a way known in and of itself, thin powder layers of a high-temperature-resistant metal alloy are introduced onto a platform (not shown) of the additive manufacturing unit 12, locally melted by means of the laser 22, and solidified by cooling. Subsequently the platform is lowered, another powder layer is introduced and again solidified. This cycle is repeated until component 14 is produced. An exemplary component 14 is composed of up to 2000 component layers and has a total layer height of 40 mm. The finished component 14 can be further processed subsequently or can be used immediately.

In the case of the method according to the invention, the uppermost layer of component 14 each time will be subjected to a heat treatment below the melting point of the material of the component. This heat treatment causes the uppermost layer to radiate heat, which can be detected by means of a thermographic unit 18. The radiated heat of the uppermost layer is adjusted so that it lies within the infrared region at the edge of the visible spectrum and also within the sensitivity region of the thermographic unit 18.

The heat profile in the uppermost layer of component 14, which has been produced by an energy source, e.g. laser 22 or an additional energy source, in this case will be determined by means of the thermographic unit 18, in the form of a layer image 24 (see FIG. 3). The heat profile in the uppermost layer of component 14, and optionally further information derived therefrom, will be subsequently spatially resolved and visualized by means of a display unit 32 (FIG. 5), for example, coded via brightness values and/or colors.

During the inspection of component 14, the latter is arranged without encasing or enclosure in the additive manufacturing unit 12. An encasing or enclosure is not necessary, since the thermographic unit 18 does not have any effect on the heat profile in component 14 either during the additive manufacture or during the inspection of component 14.

Not only is geometric information obtained by optical thermography, but information is also obtained on the local temperature distribution in the component layer in question. In this case, it can be basically provided that the layer image 24 is composed of several individual images. For example, depending on the surface area of the build-up space 16, the layer image 24 can be composed of up to 1,000 individual images or more per component layer, or can be composed of individual images, each of which images between 0.1 cm 2 and 1.0 cm of the individual component layer. The exposure time per image lies between 1 ms and 5000 ms, preferably between 50 ms and 500 ms, as necessary.

Basically, it can be provided that the distance traveled by the laser beam per individual image amounts to between 10 mm and 120 mm, thus, for example, 10 mm, 20 mm, 30 mm, 40 mm, 50 mm, 60 mm, 70 mm, 80 mm, 90 mm, 100 mm, 110 mm or 120 mm. In addition, it can be basically provided that each layer image 24 is determined within 2 minutes, in order to avoid intense cooling of the component layers and thus also to avoid a concomitant loss of information.

By way of example, FIG. 3 shows a layer image 24 of several components 14, which are produced together in the build-up space 16 of the manufacturing unit 12 and are presently shown as rotor blades for an aircraft engine, which are built up layer by layer in a direction perpendicular to their lengthwise dimension. The layer image can be shown, for example, on at least one display unit 32 (FIG. 5). It is recognized that the layer image 24 images the entire build-up space 16, without overlap. Many excerpts of details for any component 14 can be enlarged as desired. The maximum enlargement of the detail excerpts depends on the resolution capacity of the thermographic unit 18.

A detail and the associated enlargement of this detail for one of components 14 are characterized by the reference number III, wherein the corresponding component 14 has a crack 30, which is shown schematically, in its uppermost layer. The crack 30 can be a hot crack or a segmentation crack. The reference number IV characterizes a specific excerpt from detail III, wherein the excerpt IV includes the crack 30.

FIG. 4 shows an additional enlargement of excerpt IV in a schematic perspective view of the excerpt. As an example, three layers 26, 28 of component 14 are shown here. However, component 14 may also comprise more or fewer layers 26, depending on the instantaneous manufacturing state. The two layers 26 shown here are crack-free layers, whose absence of cracks could be established by means of the thermographic unit 18, so that the manufacturing process was conducted further. The uppermost layer of component 14 is a layer 28 affected by a crack.

The profile and the form of crack 30 are only shown schematically here. More than one crack 30 may also occur in layer 28. The crack can assume any form whatever. The length and the width of crack 30 may vary and lie in the range of a few micrometers. These small dimensions can only be detected by means of the thermographic unit 18. In addition, cracks 30 of this order of magnitude can be brought into the optical detection range of the thermographic unit only by the corresponding heat treatment described above.

If the length and/or the maximum width of the crack 30 is (are) less than specific limit values, the additive manufacture can be continued. If the limit values, however, are reached or exceeded, the production process for the corresponding component 14 will be terminated prematurely or the layer 28 of component 14 affected by the crack will be corrected by a re-melting.

According to FIG. 5, each layer 26, 28 is detected optically by means of the thermographic unit 18 and depicted on display unit 32. Also, the thermographic unit works in conjunction with at least one evaluating unit 34, so that the recorded images are classified and stored therein, and, optionally, an order can be triggered for interrupting the additive manufacturing process of one or more components 14 affected by a crack. The evaluating unit 34 is configured so that it can recognize the crack 30 in the uppermost layer 28 of component 14 by means of an algorithm. These procedures, however, can also be conducted manually by an operator after evaluation of the images or recordings from the thermographic unit 18 on the display unit 32.

If, by means of the thermographic unit 18 and the evaluating unit 34, it is recognized that the layer 28 of component 14 is affected by a crack, the additive manufacturing process can be interrupted and the crack-affected layer 28 can be corrected by re-melting. The re-melting of the crack-affected layer 28 is carried out, for example, as follows: upon automatic detection of a crack 30, the evaluating unit 34 provides a corresponding order to the control 38 of laser 22 to interrupt the additive manufacturing process and provide re-melting.

Alternatively, the additive manufacturing process can be terminated prematurely for a single crack-affected component 14 or a plurality of crack-affected components 14. This is conducted by a manually triggered order or an order triggered automatically by the evaluating unit 34 to the control 38 of laser 22.

The premature termination of the additive manufacturing process will preferably be carried out when component 14 has only a small number of layers 26, 28. When component 14 is almost finished, an interruption and a re-melting of layer 28 is preferred.

Very generally, the evaluating unit 34 can also trigger an alarm by means of a signaling unit 36, in the form of acoustic or optical signals, e.g., in the form of a warning message on the display unit 32 or another computing unit (not shown) connected to the additive manufacturing unit 12. Then an operator can decide whether and how the additive manufacture of components 14 will be continued.

The evaluating unit 34 and the signaling unit 36, including the necessary signal lines between the thermographic unit 18, the evaluating unit, the signaling unit 36, and the control 38 of laser 22 of additive manufacturing unit 12 are components of device 10.

The invention relates to a method for the quality assurance of at least one component during the production thereof, wherein the production is carried out by means of at least one additive manufacturing method, which comprises the following steps:
building up the component layer by layer;
thermographically recording at least one image of each individual layer applied.

In order to make possible a nondestructive inspection of cracks of a metal component during the production process (inspection by means of an online method), at least some of the applied layers are subjected to a controlled heat treatment below the melting point of the component material prior to thermographically recording the associated image, wherein the heat treatment induces the last layer applied to radiate heat, and when at least one crack occurs in the layer, this radiated heat has a characteristic heat profile at the crack, wherein the heat profile, and consequently the crack, are made visible by means of the associated thermographic recording. Preferably, each layer applied is subjected to such a treatment.

### LIST OF REFERENCE SYMBOLS

10 Device
12 Additive manufacturing unit
14 Component
16 Build-up space
18 Thermographic unit
20 Laser protection glass
22 Laser
24 Layer image
26 Crack-free layer
28 Crack-affected layer
30 Crack
32 Display unit
34 Evaluating unit
36 Signaling unit
38 Control
II Beam path of the laser
III Detail
IV Excerpt

1. A method for the quality assurance of at least one component (14) during the production thereof, wherein the production is carried out by at least one additive manufacturing comprising the steps of:
building up the component layer by layer (14);
thermographically recording at least one image of each individual layer (26, 28) applied, wherein
at least some of the applied layers (26, 28) are subjected to a controlled heat treatment below the melting point of the component material prior to the thermographic recording of the associated image, wherein the heat treatment induces the last layer applied to radiate heat, and when at least one crack (30) occurs in the layer (28), this radiated heat has a characteristic heat profile at the crack (30), wherein the heat profile, and consequently the crack (30), are made visible by of the associated thermographic recording.

2. The method according to claim 1, wherein the controlled heat treatment produces radiated heat in the layer (26, 28), which lies in the infrared region at the edge of the visible spectrum and within the detection spectrum of a thermographic unit (18).

3. The method according to claim 1, wherein at least one energy source required for the additive manufacturing method, is a laser (22) that carries out the heat treatment.

4. The method according to claim 1, wherein at least one energy source that is independent of the additive manufacturing method carries out the heat treatment.

5. The method according to claim 1, wherein the additive manufacturing method is a selective laser melting and/or a selective laser sintering.

6. The method according to claim 1, wherein the crack (30) is corrected by the re-melting of the risk-affected layer (28).

7. The method according to claim 6, wherein the images recorded by the thermographic unit (18) are analyzed, and if a crack (30) is detected, a signaling unit is activated and/or a re-melting of the crack-affected layer (28) is triggered.

8. The method according to claim 1, further comprising the step of:
providing at least one additive manufacturing unit (12) and at least one thermographic unit (18), wherein the device (10) comprises at least one energy source (22), by which the controlled heat treatment of each individual layer (26, 28) is conducted.

9. The method according to claim 8, wherein the energy source (22) for the additive manufacturing unit (12) is simultaneously the energy source for the controlled heat treatment.

10. The method according to claim 8, wherein the energy source (22) for the additive manufacturing unit (12) is independent from the energy source for the controlled heat treatment.

11. The method according to claim 8, wherein the thermographic unit (18) comprises a high-resolution image-recording device and/or an image-recording device that is sensitive to infrared radiation, and includes CCD, CMOS, or sCMOS sensors.

12. The method according to claim 11, wherein the component (14) is arranged without an encasing or enclosure in the additive manufacturing unit (12) during inspection.

13. The method according to claim 8, wherein the device (10) comprises at least one display unit (32), at least one evaluating unit (34), at least one signaling unit (36) for reporting a crack (30), and at least one control (38) of the energy source for the additive manufacturing unit (12).
